(19) United States
(12) Patent Application Publication
(10) Pub. No.: US 2018/0086154 A1
(43) Pub. Date: Mar. 29, 2018

(54) PNEUMATIC TIRE

(71) Applicant: TOYO TIRE & RUBBER CO., LTD., Osaka (JP)

(72) Inventor: Kouichi Takita, Osaka-shi (JP)

(73) Assignee: TOYO TIRE & RUBBER CO., LTD., Osaka (JP)

(21) Appl. No.: 15/498,608

(22) Filed: Apr. 27, 2017

(30) Foreign Application Priority Data
Sep. 27, 2016 (JP) 2016-188103

(51) Int. Cl. B60C 13/02; B60C 11/01

(52) U.S. Cl. CPC B60C 13/02; B60C 11/01

(57) ABSTRACT

A pneumatic tire has a pair of bead portions, side wall portions and a tread portion. An annular projections group in which plural kinds of projections having different volumes are arranged in a tire circumferential direction, is formed on an outer surface of a buttress region of the side vail portion. On the assumption that a virtual line is defined by connecting a maximum height position at the center in a width direction of a projection included in the annular projections group, and a maximum height position at the center in the width direction of another projection which is adjacent to the projection, an angle of inclination θ formed by the virtual line and an outer-surface in the buttress region of the side wall portion in a tire diametrical direction view goes beyond 3 degrees and is equal to or less than 13 degrees.

### BACKGROUND OF THE INVENTION

### Field of the Invention

The present invention relates to a pneumatic tire aiming at traveling on a punishing road such as a muddy terrain and a rocky stretch.

### Description of the Related Art

With regard to the pneumatic tire aiming at the traveling on the punishing road, there has been known a technique in which an annular projections group having a plurality of projections arranged in a tire circumferential direction is formed on an outer surface of a buttress region of a side wall portion. For example, Patent Documents 1 to 3 filed by the applicant of the present application should be referred. According to the configuration mentioned above, in a scene traveling on a muddy terrain and a sand pip, traction is generated by shear resistance of the projections and it is possible to improve a punishing road traveling property.

The Patent Document 1 discloses an example in which a plurality of projections included in an annular projections group are uniformly provided and sizes of the projections are fixed. Meanwhile, in recent years, there has been proposed a structure in which projections having different magnitudes and shapes are arranged, for improving a catching action in the rocky stretch and enhancing a design property by applying a stereoscopic effect to the buttress region.

However, in the case that the annular projections group is formed by plural kinds of projections having different volumes, a fluctuation in a thickness of the buttress region is enlarged along the tire circumferential direction. As a result, there is generated a portion where the rubber does not sufficiently circulate around at the curing time, and there is a case that a rubber defect called as a bare is generated in the projections of the molded tire. Further, dynamic unbalance of the tire tends to be deteriorated on the basis of the enlargement in the fluctuation of the thickness in the buttress region.

### PRIOR ART DOCUMENT

### Patent Document

Patent Document 1: JP-A-2004-291936
Patent Document 2: JP-A-2010-264962
Patent Document 3: JP-A-2013-119277

### SUMMARY OF THE INVENTION

The present invention is made by taking the above actual condition into consideration, and an object of the present invention is to provide a pneumatic tire which can suppress generation of a bare and reduce dynamic unbalance while forming an annular projections group in which plural kinds of projections having different volumes are arranged.

The object can be achieved by the following present invention. The present invention provides a pneumatic tire comprising a pair of bead portions, side wall portions which extend outward in a tire diametrical direction from each of the bead portions, and a tread portion which is connected to an outside end in the tire diametrical direction of each of the side wall portions, wherein an annular projections group in which plural kinds of projections having different volumes are arranged in a tire circumferential direction, is formed on an outer surface of a buttress region of the side wall portion, wherein on the assumption that a virtual line is defined by connecting a maximum height position at the center in a width direction of a projection included in the annular projections group, and a maximum height position at the center in the width direction of another projection which is adjacent to the projection, an angle of inclination θ formed by the virtual line and an outer surface in the buttress region of the side wall portion in a tire diametrical direction view goes beyond 3 degrees and is equal to or less than 13 degrees.

In the tire, since the angle of inclination θ mentioned above goes beyond 3 degrees while forming the annular projections obtained by arranging the plural kinds of projections having the different volumes, there can be appropriately obtained an effect of improving a catching action on the rocky stretch and enhancing a design property by applying a stereoscopic effect to the buttress region. More specifically, if the angle of inclination θ is equal to or less than 3 degrees, a difference in the maximum height between the adjacent projections is small, and the above effect is hard to be obtained. Further, since the angle of inclination θ mentioned above is equal to or less than 13 degrees in the tire, the difference in the maximum height between the adjacent projections does not become too large, it is possible to suppress fluctuation in the thickness of the buttress region. As a result, it is possible to reduce dynamic imbalance as well as suppressing generation of a bare.

In the case that the angle of inclination θ mentioned above is equal to or less than 11 degrees, it is possible to more effectively reduce the dynamic unbalance as well as suppressing the generation of the bare.

It is preferable that a circumferential rib extending in the tire circumferential direction and connecting the projections each other is formed on the outer surface of the buttress region in the side wall portion. The rigidity of each of the projections is enhanced by the connection with the circumferential rib, and it is possible to improve the traction caused by the shear resistance of the projections.

### BRIEF DESCRIPTION OF THE DRAWINGS

FIG. 1 is a tire meridian half cross sectional view schematically showing an example of a pneumatic tire according to the present invention;

FIG. 2 is a side elevational view showing apart of abut tress region of the tire as seen from a tire width direction;

FIG. 3 is an enlarged view of a substantial part in FIG. 1;

FIGS. 4A to 4C are views for describing a maximum height position and a virtual line of projections;

FIG. 5 is a view for describing a relationship between the maximum height position and a minimum height position;

FIG. 6 is a view for describing a relationship between the maximum height position and a minimum height position; and

FIG. 7 is a view for describing a relationship between the maximum height position and a minimum height position.

### DETAILED DESCRIPTION OF THE PREFERRED EMBODIMENTS

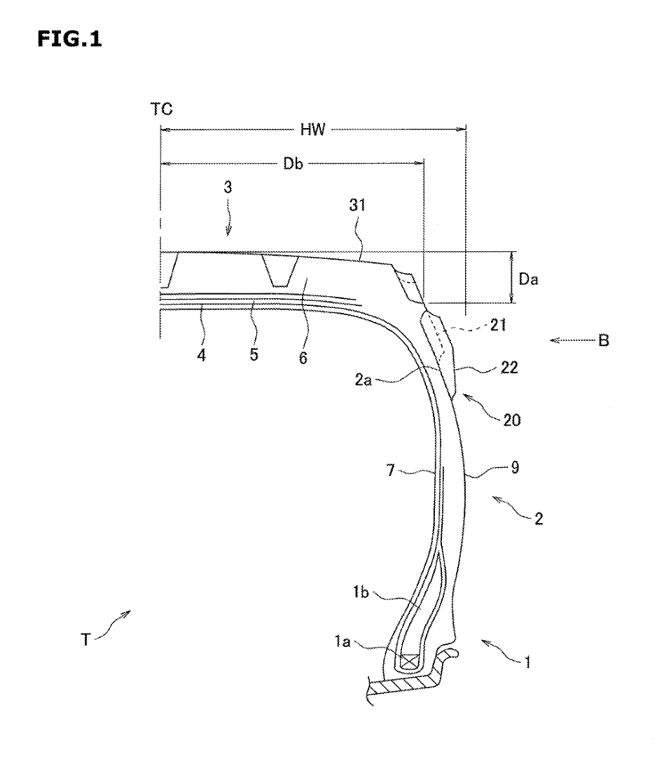

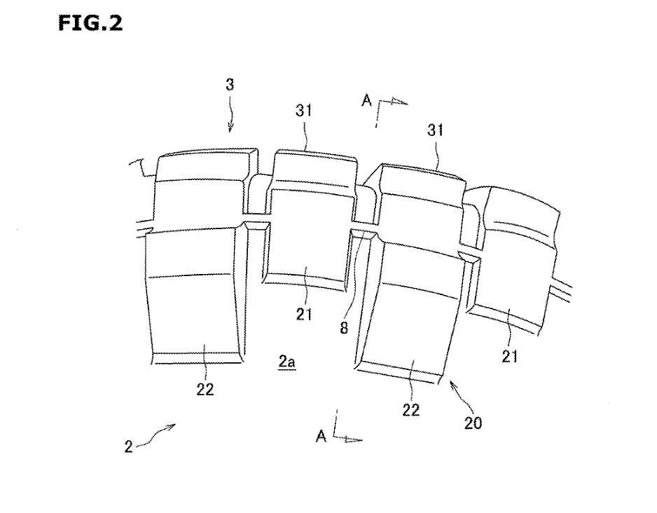

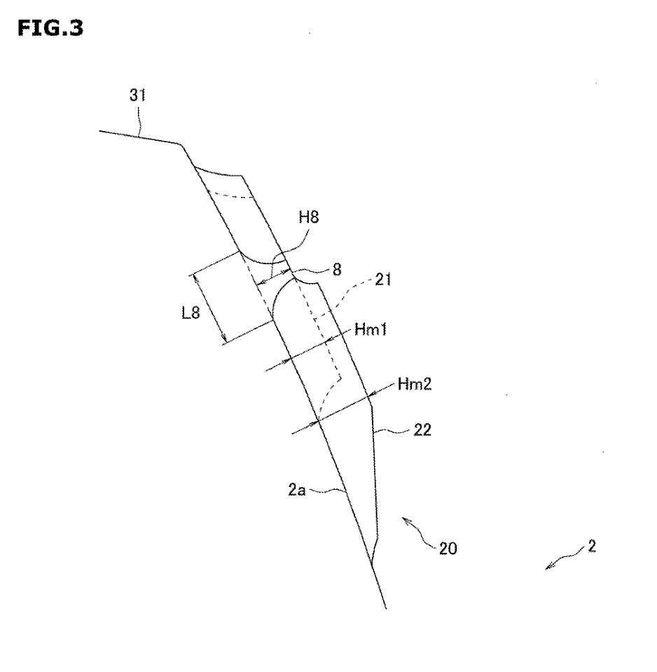

An embodiment of the present invention will be explained with reference to the drawings. FIG. 1 is a tire meridian half cross sectional view schematically showing an example of a pneumatic tire according to the present invention, and corresponds to a cross sectional view along a line A-A in FIG. 2. FIG. 2 is a side elevational view showing a part of a buttress region as seen from a tire width direction, and corresponds to a view as seen from an arrow B in FIG. 1. FIG. 3 is an enlarged view of a substantial part in FIG. 1.

A pneumatic tire T is an off-road pneumatic radial tire aiming at traveling on a punishing road which includes a muddy terrain and a rocky stretch. The tire T is provided with a pair of bead portions 1, side wall portions 2 which extend outward in a tire diametrical direction from each of the bead portions 1, and a tread portion 3 which is connected to an outside end in the tire diametrical direction of each of the side wall portions 2. The bead portion 1 is provided with an annular bead core 1a formed by coating a convergence body of steel wire with rubber, and a bead filler 1b which is arranged in an outer side in the tire diametrical direction of the bead core 1a.

The pneumatic tire T is further provided with a carcass 4 which is arranged between a pair of bead portions 1, and a belt 5 which is arranged in an outer peripheral side of the carcass 4 in the tread portion 3. The carcass 4 is formed into a toroidal shape as a whole, and is wound up its end portion in such a manner as to pinch the bead core 1a and the bead filler 1b. The belt 5 includes two belt plies which are layered inward and outward, and is provided with a tread rubber 6 in its outer peripheral side. A tread pattern is formed on a surface of the tread rubber 6.

An inner liner 7 is provided in an inner peripheral side of the carcass 4 for keeping pneumatic pressure. The inner liner 7 faces to an internal space of the tire T in which air is filled. In the side wall portion 2, the inner liner 7 is directly attached to an inner peripheral side of the carcass 4, and any other member is not interposed between them.

As shown in FIGS. 2 and 3, an annular projections group 20 in which plural kinds (two kinds in the present embodiment) of projections 21 and 22 having different, volumes are arranged in a tire circumferential direction is formed on an outer surface 2a of a buttress region of the side wall portion 2. The buttress region is a region in an outer side in a tire diametrical direction of the side wall portion 2, and more particularly a region in the outer side in the tire diametrical direction from a tire maximum width position 9, and corresponds to a region which does not ground contact at the normal traveling time on a flat paved road. Since the tire sinks down on a soft road such as the muddy terrain and the sand pip due to a weight of a vehicle, the buttress region ground contacts in a pseudo manner.

In the present embodiment, there is shown an example in which two kinds of projections 21 and 22 having different volumes are alternately arranged. A width of a gap existing between the adjacent projections 21 and 22 is set to be smaller than a width of each of the projections 21 and 22 in both sides of the gap. The projection 21 and the projection 22 are alternately arranged in the same manner in the other portions which are not shown, and an arrangement body thereof constructs an annular projections group 20. The projections constructing the annular projections group are not limited to two kinds, but the annular projections group may be formed by arranging three or more kinds (for example, three to ten kinds) of projections having different volumes.

Each of the projections 21 and 22 constructing the annular projections group 20 bulges from the outer surface 2a of the side wall portion 2 along a profile line of the tire T, and the volume of each of the projections 21 and 22 is determined on the basis of the portion bulging from the outer surface 2a. In the present embodiment, there is shown an example in which a circumferential rib 8 is formed in the buttress, region as mentioned later, however, a portion of the circumferential rib 8 protruding out of a side surface of each of the projections 21 and 22 is not considered as the volume of the projections 21 and 22 in this case.

The volume of the projection can be determined, for example, by measuring concavities and convexities of the side wall portion with using a three-dimensional measuring tool and preparing a three-dimensional modeling while combining actually measured dimensional values as occasion demands. Alternatively, it can be determined by molding the side wall portion with using gypsum and utilizing the gypsum mold.

As shown in FIG. 2, each of the projections 21 and 22 is formed into a rectangular shape in a side view, however, may be formed into the other polygonal shapes than the rectangular shape or the other shapes without being limited to this. In the present embodiment, each of the projections 21 and 22 extends in the tire diametrical direction, and a tire diametrical outside end (hereinafter, referred to as an outside end) thereof is connected to a side surface of a land portion 31 in the tread portion 3. Further, a tire diametrical inside end (hereinafter, referred to as an inside end) is arranged in an outer side in the tire diametrical direction than the tire maximum width position 9.

The tire maximum width position 9 is a position where a profile line of the tier T is away from a tire equator TC at the maximum in the tire width direction. The profile line is a contour line which forms an outer surface of the side wall portion 2 except the projections, and normally has a meridian cross sectional shape which is defined by smoothly connecting a plurality of circular arcs.

In the present embodiment, the height, of the projection 21 based on the outer surface 2a is fixed, from, the edge of the outside end to the edge of the inside end as shown in FIG. 3, however, the height of the projection 22 based on the outer surface 2a is changed along the tire diametrical direction. The greater the maximum heights Hm1 and Hm2 of the projections 21 and 22 are, the more the traction caused by the shear resistance can be enhanced and the more the punishing road traveling property can be improved. Further, the external damage resistance can be improved by keeping the external damage factor such as the angular portion of the rock face away from the outer surface 2a. In the light of the above, each of the height Hm1 and the height Hm2 is preferably equal to or more than 5 mm, and more preferably equal to or more than 8 mm.

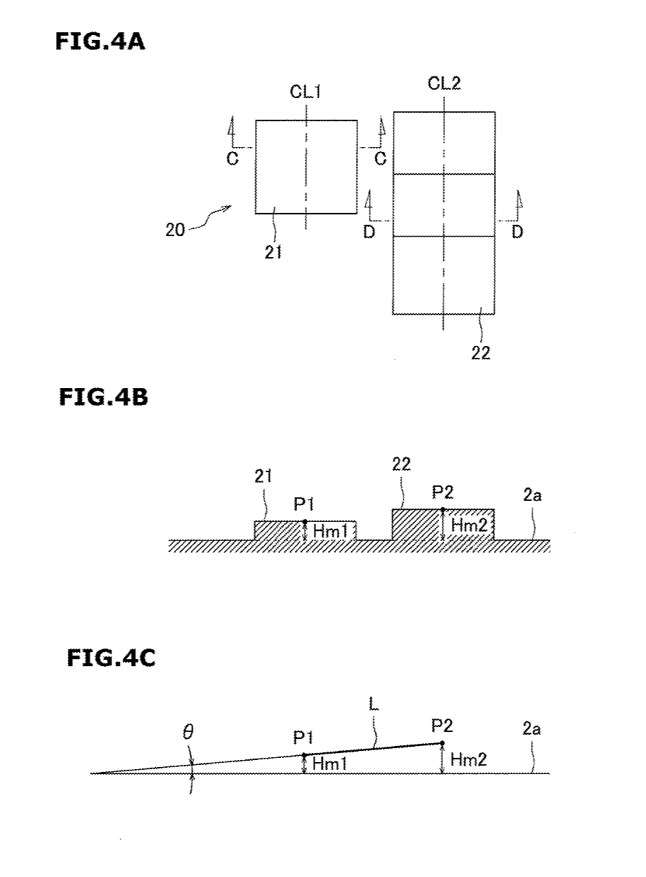

FIGS. 4A to 4C show a positional relationship between the projection 21 which is included in the annular projections group 20, and the different projection which is adjacent to the projection 21 in the tire circumferential direction, that is, the projection 22. FIG. 4A shows the projections 21 and 22 in a side view, and center lines CL1 and CL2 are defined so as to pass through the center in the width direction thereof. FIG. 4B shows cross sections of the projections 21 and 22 at a position where the height from the outer surface 2a becomes maximum on the center lines CL1 and CL2. They may be positions which are away in the tire diametrical direction, for example, such as a cross section along a line C-C and a cross section along a line D-D. FIG. 4C draws the maximum height positions P1 and P2 and the outer surface 2a in FIG. 4B.

In FIG. 4B, there is shown the cross sections of the projections 21 and 22 as seen from the tire diametrical direction, more specifically, as seen along a profile line from the tire diametrical direction (in other words, as seen from a tire meridian direction), and the maximum height positions P1 and P2 are away at the maximum height Hm1 and Hm2 from the outer surface 2a, respectively. The angle of inclination θ in FIG. 4C is an angle formed by a virtual line L and the outer surface 2a as seen front the tire diametrical direction on the assumption that the virtual line L is defined by connecting the maximum height position P1 at the center in the width direction ox the projection 21, and the maximum height position P2 at the center in the width direction of the different projection 22 which is adjacent to the projection 21. The angle of inclination θ is an angle which goes beyond 3 degrees and is equal to or less than 13 degrees, and each of the projections constructing the annular projections group 20 satisfies the relationship.

In the tire T, since the angle of inclination θ goes beyond 3 degrees while forming the annular projections group 20 as mentioned above, there can be appropriately obtained an effect of improving the catching action on the rocky stretch and enhancing the design property by applying the stereoscopic effect to the buttress region. On the other hand, in the case that the angle of inclination θ is equal to or less than 3 degrees, the difference between the maximum heights of the adjacent projections 21 and 22 is small, and the effect mentioned above is hard to be obtained. Further, since the angle of inclination θ is equal to or less than 13 degrees in the tire T, the difference between the maximum heights of the adjacent projections 21 and 22 does not become too large, and the fluctuation in the thickness of the buttress region can be suppressed. As a result, it is possible to suppress generation of the bare and it is also possible to reduce the dynamic unbalance.

In the case that the angle of inclination θ is equal to or less than 11 degrees, it is possible to more effectively suppress the generation of the bare and it is also possible to more effectively reduce the dynamic unbalance.

The greater the difference between the maximum heights Hm1 and Hm2 of the adjacent projections 21 and 22, particularly in the case that the distance therebetween (the distance in the tire circumferential direction) is small, the fluctuation in the thickness of the buttress region along the tire circumferential direction is rapid. As a result, the generation of the bare and the deterioration of the dynamic unbalance tend to be caused. Therefore, the relationship of the adjacent projections 21 and 22 is defined by the angle of inclination θ which is determined on the basis of the maximum heights Hm1 and Hm2 and the distance, as described above.

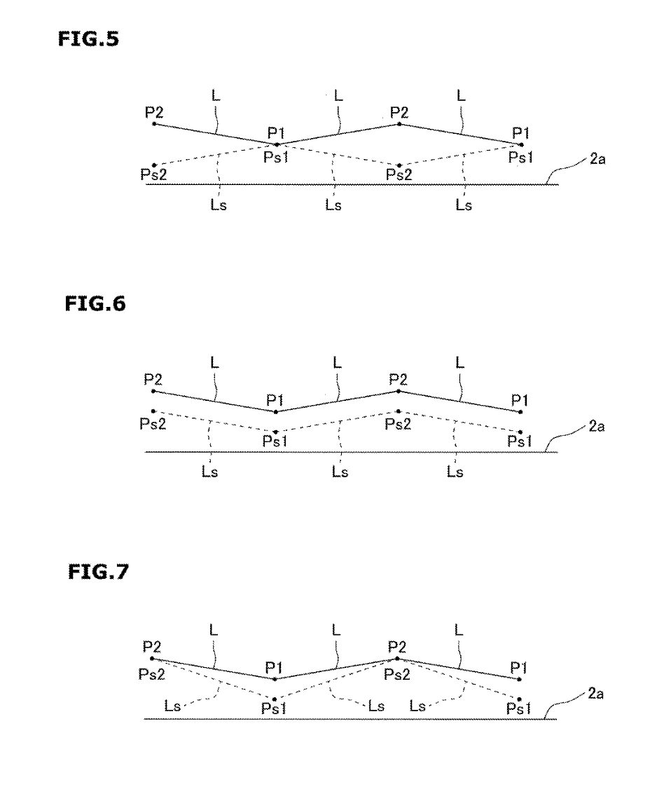

FIG. 5 shows maximum height positions P1 and P2 of four projections which are arranged in the tire circumferential direction, and three virtual lines L which are defined by the already mentioned manner. The angles of inclination formed by the virtual lines L and the outer surface 2a all go beyond 3 degrees, and are all equal to or less than 13 degrees. Further, the drawing shows minimum height positions Ps1 and Ps2 at the center in the width direction of the projections 21 and 22, and the virtual line Ls connecting them. As a matter of convenience for explanation, the distances of the maximum height positions P1 and P2 from the outer surface 2a and the inclination of the virtual line L are drawn greater than FIG. 4.

In the present embodiment, since the height of the projections 21 is fixed, the minimum height position Ps1 coincides with the maximum height position P1. The minimum height position Ps2 of the projections 22 exists at a position which is lower than the minimum height position Ps1 of the projections 21, and the distance from the outer surface 2a is relatively small. In the example in FIG. 5, the virtual line Ls connecting the minimum height position Ps1 and the minimum height position Ps2 is inclined in an inverse direction to the virtual line L. In this case, the traction caused by the shear resistance of the projections tends to be enhanced.

FIGS. 6 and 7 are modified examples in which the modes of the minimum height positions Ps1 and Ps2 are differentiated. In these examples, the virtual line Ls is inclined in the same direction as the virtual line L. In this case, the generation of the bare in the projections tends to be better suppressed. Among them, the inclination of the virtual line Ls is greater than the inclination of the virtual line L in the example in FIG. 7, so that the traction tends to be enhanced in comparison with the example in FIG. 6.

In the present embodiment, a circumferential rib 8 extending in the tire circumferential direction and connecting the projections each other is formed on the outer surface 2a in the buttress region of the side wall portion 2. The rigidity of each of the projections 21 and 22 is enhanced by the connection with the circumferential rib 8, and it is possible to improve the traction caused by the shear resistance of the projection. The circumferential rib 8 extends on an annular line which is along the tire circumferential direction. Each of the projections 21 and 22 extends to an inner side and an outer side in the tire diametrical direction from the circumferential rib 8, however, preferably extends at least to the inner side in the tire diametrical direction from the circumferential rib 8. It is preferable that the maximum heights Hm1 and Hm2 can be measured in the inner side in the tire diametrical direction than the circumferential rib 8.

A cross sectional shape of the circumferential rib 8 is formed into a flat chevron shape in its upper end surface, and more particularly formed into a composite volcano shape that an inclined surface is gently carved and narrowed. In the light of enhancement in the rigidity of the projection, a height H8 of the circumferential rib 8 is preferably equal to or more than 5 mm, more preferably goes beyond 5 mm, and is further preferably equal to or more than 8 mm. In the light of enhancement in the rigidity of the projection, a contact length L8 of the circumferential rib 8 in relation to the outer surface 2a is preferably equal to or more than the height H8.

The circumferential rib 8 is set, for example, to a position where a distance Da shown in FIG. 1 is in a range between 20 and 40 mm. The distance Da is determined as a distance in the tire diametrical direction from a position of the outermost diameter of the tire T to a tire diametrical outside edge of an upper end surface of the circumferential rib 8. Further, the circumferential rib 8 is set, for example, to a position where a distance Db shown in FIG. 1 is 75% or more of a tire cross section half width HW. The distance Db is determined as a distance in the tire width direction from the tire equator TC to the tire diametrical outside edge of the upper end surface of the circumferential rib 8, and the tire cross section half width HW is determined as a distance in the tire width direction from the tire equator TC to the tire maximum width position 9.

The annular projections group 20 may be formed in the side wall portion 2 at least in one side, however, in order to improve the punishing road traveling property and the external damage resistance, it is preferably formed in the side wall portions 2 in both sides.

Each of the dimensional values mentioned above is measured in a no-load normal state in which the tire is installed to a normal rim and a normal internal pressure is filled in the tire. The normal rim is a rim which is defined by a standard for every tire in a standard system including the standard on which the tire is based, for example, a standard rim in JATMA, “Design Rim” in TRA or “Measuring Rim” in ETRTO. Further, the normal internal pressure is a pneumatic pressure which is defined by each of the standards for every tire in the standard system including the standard on which the tire is based, and is a maximum pneumatic pressure in JATMA, the maximum value described in Table “TIRE LOAD LIMITS AT VARIOUS COLD INFLATION PRESSURES” in TRA, or “INFLATION PRESSURE” in ETRTO.

Since the pneumatic tire according to the present invention has the annular projections group which can improve the punishing road traveling property, the pneumatic tire can be preferably employed in a light truck such as a pickup truck for an off-road racing aiming at traveling on the punishing road including the muddy terrain and the rocky stretch, and for a vehicle dispatched to a disaster site.

The pneumatic tire according to the present invention can be configured in the same manner as the regular pneumatic tire except the formation of the annular projections group as mentioned above in the buttress region of the side wall portion. Therefore, the conventionally known materials, shapes, structures and manufacturing methods can be employed in the present invention.

The present invention is not limited to the embodiment mentioned above, but can be improved and modified variously within the scope of the present invention.

### EXAMPLES

A description will be given below of examples which particularly indicate the configuration and the effect of the present invention. Evaluation of each of performances of the tire was carried out by the following items (1) and (2).

### (1) Bare Generation Circumstance

In a cured tire, “with” was evaluated in the case that a bare was recognized in a projection constructing an annular projections group in a buttress region, and an outer appearance quality thereof deflected from an allowable level. Further, “without” was evaluated in the case that, the bare was not recognized and the case that the bare was somewhat recognized and the outer appearance quality was in the allowable level.

### (2) Dynamic Unbalance (DUB)

In the cured tire, dynamic unbalance (DUB) was measured by using a dynamic balance inspection device which was installed in a uniformity measuring line of a tire manufacturing factory. The smaller the numerical value is, the lower and better the dynamic unbalance is.

The pneumatic tires described in the Patent Documents 2 and 3 were set to comparative examples 1 and 2, and the pneumatic tires having the configuration described in the embodiment mentioned above were set to working examples 1 to 3. Further, the pneumatic tire having the same configuration as the comparative example 1 except a point that the projections included in the annular projections group were uniformly provided was set to comparative example 3. In Table 1, the description “plural kinds” means a matter that the annular projections group is formed by plural kinds of projections having different volumes, and the description “one kind” means a matter that the annular projections group is formed by one kind of projections.

TABLE 1

| | Comparative | Comparative | Comparative | Working | Working | Working |
|---|---|---|---|---|---|---|
| | example 1 | example 2 | example 3 | Example 1 | Example 2 | Example 3 |
| Projections | Plural | Plural | One | Plural | Plural | Plural |
| | kinds | kinds | kind | kinds | kinds | kinds |
| Angle of | 14 or | 14 or | 0 | 13 | 4 | 9 |
| inclination | more | more | | | | |
| (degrees) | | | | | | |
| Generation | With | With | Without | Without | Without | Without |
| of bare | | | | | | |
| DUB | 120 g | 120 g | 80 g | 100 g | 90 g | 95 g |

In the working examples 1 to 3, the generation of bare is suppressed in comparison with the comparative examples 1 and 2, and the dynamic unbalance can be reduced. Further, in the comparative example 3, since a plurality of projections included in the annular projections group are uniformly provided, it is impossible to obtain the effect of improving the catching action on the rocky stretch and enhancing the design property by applying the stereoscopic effect to the buttress region. On the contrary, the working examples 1 to 3 can obtain the above effects since the annular projections group is formed by the plural kinds of projections having different volumes.

What is claimed is:

1. A pneumatic tire comprising:
a pair of bead portions;
side wall portions which extend outward in a tire diametrical direction from each of the bead portions; and
a tread portion which is connected to an outside end in the tire diametrical direction of each of the side wall portions,
wherein an annular projections group in which plural kinds of projections having different volumes are arranged in a tire circumferential direction, is formed on an outer surface of a buttress region of the side wall portion,
wherein on the assumption that a virtual line is defined by connecting a maximum height position at the center in a width direction of a projection included in the annular projections group, and a maximum height position at the center in the width direction of another projection which is adjacent to the projection, an angle of inclination θ formed by the virtual line and an outer surface in the buttress region of the side wall portion in a tire diametrical direction view goes beyond 3 degrees and is equal to or less than 13 degrees.

2. The pneumatic tire according to claim 1, wherein the angle of inclination θ is equal to or less than 11 degrees.

3. The pneumatic tire according to claim 1, wherein a circumferential rib extending in the tire circumferential direction and connecting the projections each other is formed on the outer surface of the buttress region in the side wall portion.

4. The pneumatic tire according to claim 1, wherein the annular projections group is formed by alternately arranging two kinds of projections having different volumes.

5. The pneumatic tire according to claim 1, wherein the annular projections group is formed by arranging three or more kinds of projections having different volumes.

6. The pneumatic tire according to claim 1, wherein a width of a gap existing between the adjacent projections is set to be smaller than a width of each of the projections existing in both sides of the gap.

7. The pneumatic tire according to claim 1, wherein each of the projections extends in the tire diametrical direction, and a tire diametrical outside end thereof is connected to a side surface of a land portion of the tread portion.

8. The pneumatic tire according to claim 1, wherein each of the projections extends in the tire diametrical direction, and a tire diametrical inside end thereof is arranged in an outer side in the tire diametrical direction than a tire maximum width position.
